(19) United States
(12) Patent Application Publication
(10) Pub. No.: US 2026/0001437 A1
(43) Pub. Date: Jan. 1, 2026

(54) CHARGING DEVICE FOR ELECTRIC VEHICLE AND METHOD OF CHARGING THE SAME

(71) Applicant: Hyundai Kefico Corporation, Gunpo (KR)

(72) Inventor: Ji Hoon Jung, Gunpo (KR)

(21) Appl. No.: 19/254,527

(22) Filed: Jun. 30, 2025

(30) Foreign Application Priority Data
Jul. 1, 2024 (KR) 10-2024-0086106

(51) Int. Cl. B60L 53/66; B60L 53/31; H04B 3/54

(52) U.S. Cl. CPC B60L 53/66; H04B 3/54; B60L 53/31

(57) ABSTRACT

A charging device for an electric vehicle includes a memory configured to store a plurality of power spectra density profiles, a communication signal strength setting module configured to set a communication signal strength based on one of the plurality of power spectra density profiles stored in the memory, and a power line communication (PLC) controller configured to transmit a signal having the set communication signal strength to a charger.

### CROSS REFERENCE TO RELATED APPLICATION

The present application claims under 35 U.S.C. § 119(a) the benefit of Korean Patent Application No. 10-2024-0086106, filed Jul. 1, 2024, the entire contents of which are incorporated by reference herein.

### BACKGROUND

### (a) Technical Field

The present disclosure relates to electric vehicle charging, more particularly, to a method of charging an electric vehicle and a charging device, which address a problem of charging being interrupted due to communication interruption during charging via power line communication (PLC).

### (b) Description of the Related Art

To charge an electric vehicle, communication between the electric vehicle and a charger is required. Although a communication interface used in each country is different, the most commonly used ISO15118 standard uses power line communication (PLC) as a communication technology between an electric vehicle and a charging system.

FIG. 1 (RELATED ART) shows a configuration diagram showing electric vehicles 22 and 24 and electric chargers 12 and 14 connected by a power line in order to charge the electric vehicles at an electric charging station. However, an association issue occurs between the electric vehicles 22 and 24 and the electric chargers 12 and 14 connected by the power line.

As shown in FIG. 1, when two electric vehicles 22 and 24 attempt to charge or are charged by being connected to two electric chargers 12 and 14 of the charging system for charging, the electric chargers 12 and 14 use or are connected to the same power line of the charging system, and thus it is necessary to determine which electric vehicle 22 or 24 is connected to which charger 12 or 14 during charging. When an electric vehicle to be charged is physically connected to a charger, the electric vehicle transmits a message to the electric charging system via PLC, and each charger of the charging system responds to the message. The electric vehicle determines the message sent from the charger and ultimately determines to which charger it is connected.

Since various types of electric vehicles and the charging system communicate using such PLC, communication can be impossible due to various noises or communication can be interrupted during charging, making charging ultimately impossible. For example, noise from operating conditions of a power device of an electric vehicle can distort a communication signal strength that automobile manufacturers use as a standard before launch, causing intermittent interruptions in communication.

### SUMMARY

The present disclosure is directed to solving a charging interruption problem by applying various charging profiles stored in a charging controller when the charging interruption problem occurs due to communication interruption during charging via power line communication.

Accordingly, the present disclosure provides a method of charging an electric vehicle and a charging device, which solve the problem of charging interruption due to communication interruption and the inability to match communication between the electric vehicle and a charging system.

Objects of the present disclosure are not limited to the above-described object, and other objects that are not mentioned will be able to be clearly understood by those skilled in the art to which the present disclosure pertains based on the following description.

According to the present disclosure, a charging device for a vehicle includes: a memory configured to store a plurality of power spectra density profiles; a communication signal strength setting module configured to set a communication signal strength based on one of the plurality of power spectra density profiles stored in the memory; and a power line communication (PLC) controller configured to transmit a signal having the set communication signal strength to a charger.

According to one embodiment, there may be provided a charging device for an electric vehicle, which includes a memory configured to store a plurality of power spectra density profiles, a communication signal strength setting module configured to set a communication signal strength based on one of the plurality of power spectra density profiles stored in the memory, and a power line communication (PLC) controller configured to transmit a signal having the set communication signal strength to a charger.

The communication signal strength setting module may calculate a learning value for each of the plurality of power spectra density profiles, and a learning value for a power spectra density profile used when charging is successful may be calculated by adding a weighting coefficient to a previous learning value.

The communication signal strength setting module may select a power spectra density profile with a greatest learning value among the plurality of power spectra density profiles, and set a communication signal strength based on the selected power spectra density profile.

The communication signal strength setting module may randomly select one of the plurality of power spectra density profiles or select a power spectra density profile with a highest preference based on a preference set by a driver, and set a communication signal strength based on the selected power spectra density profile.

The PLC controller may determine whether the number of times the signal has been transmitted to the charger exceeds a communication interruption determination reference value when not receiving a response signal from the charger after transmitting a signal having the set communication signal strength to the charger and determine that communication is impossible and communication is interrupted when the number of times the signal has been transmitted to the charger exceeds the communication interruption determination reference value.

The PLC controller may perform charging control with a signal having the set communication signal strength when receiving the response signal from the charger, and request the communication signal strength setting module to re-set the communication signal strength when charging fails while performing the charging control.

A vehicle (or an electric vehicle) may include the above-described charging device.

According to the present disclosure, a method of charging a charging device for a vehicle may include: storing, by a memory, a plurality of power spectra density profiles; setting, by communication signal strength setting module, a communication signal strength based on the plurality of power spectra density profiles stored in the memory; and transmitting, by a power line communication (PLC) controller, a message to a charger with a signal having the set communication signal strength.

According to one embodiment, there may be provided a method of charging a charging device for an electric vehicle, which includes storing a plurality of power spectra density profiles in a memory, setting a communication signal strength based on the plurality of power spectra density profiles stored in the memory, and transmitting a message to a charger with a signal having the set communication signal strength.

The method may further include, as calculating a learn value for each of the plurality of power spectra density profiles and storing the learn values in the memory, calculating a learning value for a power spectra density profile used when charging is successful by adding a weighting coefficient to a previous learning value.

The setting of the communication signal strength may include selecting a power spectra density profile with a greatest learning value among the plurality of power spectra density profiles, and setting a communication signal strength based on the selected power spectra density profile.

The setting of the communication signal strength may include randomly selecting one of the plurality of power spectra density profiles or selecting a power spectra density profile with a highest preference based on a preference set by a driver, and setting a communication signal strength based on the selected power spectra density profile.

The method may further include determining whether the number of times the signal has been transmitted to the charger exceeds a communication interruption determination reference value when not receiving a response signal from the charger after transmitting a signal having the set communication signal strength to the charger, and determining that communication is impossible and communication is interrupted when the number of times the signal has been transmitted to the charger exceeds the communication interruption determination reference value.

The method may further include performing charging control with a signal having the set communication signal strength when receiving a response signal from the charger after transmitting a signal having the set communication signal strength to the charger, and re-setting the communication signal strength when charging fails during the performing of the charging control.

### BRIEF DESCRIPTION OF THE DRAWINGS

FIG. 1 (RELATED ART) is a view showing connection between a typical electric vehicle and a charger of a charging system.

FIG. 2 is a block diagram of an electric vehicle according to one embodiment of the present disclosure.

FIG. 3 is a view showing a plurality of power spectral density profiles stored in a memory according to one embodiment of the present disclosure.

FIG. 4 is another view showing the plurality of power spectral density profiles stored in the memory according to one embodiment of the present disclosure.

FIG. 5 is still another view showing the plurality of power spectral density profiles stored in the memory according to one embodiment of the present disclosure.

FIG. 6 is a view for describing the operation of a communication signal strength setting module according to one embodiment of the present disclosure.

FIG. 7 is a flowchart showing a method of charging an electric vehicle according to one embodiment of the present disclosure.

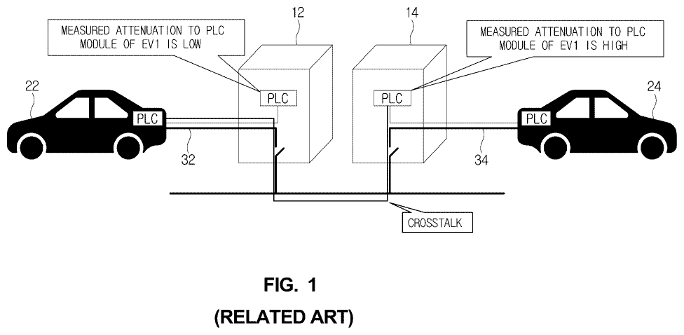

### DETAILED DESCRIPTION OF THE DISCLOSURE

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Hereinafter, various embodiments will be described in detail with reference to the accompanying drawings.

Regardless of the reference numerals, the same or similar components are denoted as the same reference numbers, and overlapping descriptions thereof may be omitted.

A suffix “module” or “unit” for components used in the following description is given or used interchangeably in consideration of ease of writing the specification and does not have meanings or roles that are distinct from each other by itself. In addition, a “module” or “unit” refers to software or a hardware component such as a field programmable gate array (FPGA) or an application specific integrated circuit (ASIC), but is not limited to software or hardware. The “unit” or “module” may be configured to be disposed in an addressable storage medium and configured to play one or more processors. Accordingly, as an example, the “unit” or “module” is components such as software components, object-oriented software components, class components, and task components, processes, functions, properties, procedures, subroutines, segments of program code, drivers, firmware, microcode, circuitry, data, databases, data structures, tables, arrays, and variables. Functions provided in one component, “units,” or “modules” may be combined with a fewer number of components and “unit” or “modules” or further separated into additional components and “units” or “modules.”

Operations of a method or algorithm described in connection with some embodiments of the present disclosure may be implemented directly in hardware and software modules executed by a processor or a combination of the two. The software modules may reside in a RAM, a flash memory, a ROM, an EPROM, an EEPROM, a register, a hard disk, a removable disk, a CD-ROM, or any other form of recording medium known in the art. An exemplary recording medium is coupled to a processor, and the processor may read information from the recording medium and write the information to the storage medium. As another method, the recording medium may be integrated with the processor. The processor and the recording medium may reside in an ASIC. The ASIC may reside in a user terminal.

Terms including ordinal numbers such as first or second may be used to describe various components, but the components are not limited by the terms. The terms are used only for the purpose of distinguishing one component from another.

When a certain component is described as being “connected” or “coupled” to another component, it should be understood that the certain component may be directly connected or coupled to another component or still another component may be present therebetween. On the other hand, when a certain component is described as being “directly connected” or “directly coupled” to another component, it should be understood that still another component is not present therebetween.

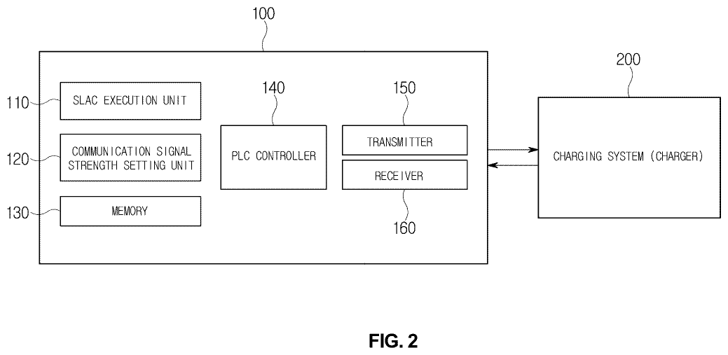

FIG. 2 is a block diagram of an electric vehicle according to one embodiment of the present disclosure.

Referring to FIG. 2, an electric vehicle 100 may include a signal level attenuation characterization (SLAC) execution unit/module 110, a communication signal strength setting unit/module 120, a memory 130, a power line communication (PLC) controller 140, a transmitter 150, and a receiver 160.

The SLAC execution unit 110 may execute a SLAC procedure to determine a charger (electric vehicle supply equipment (EVSE)) to provide electricity used for charging. SLAC may be a charger search technology based on ISO/IEC 15118-3. Specifically, the SLAC execution unit 110 may transmit a message that requests parameters that may identify a charger in order to execute the SLAC procedure. The corresponding message may be transmitted to any charger as a broadcast format message, and the charger that receives the message may reply with parameters that may identify the asset from other chargers. The SLAC execution unit 110 may transmit a notification signal indicating that it will transmit an attenuation measurement signal after confirming that it has received parameters from at least one charger and then transmit the attenuation measurement signal. When receiving the notification signal, the charger may prepare to receive the attenuation measurement signal, and when receiving the attenuation measurement signal, the charger may determine an attenuation value. According to one embodiment, to increase the accuracy of measurement, the SLAC execution unit 110 may transmit the attenuation measurement signal multiple times, and the charger may acquire an average attenuation value averaging after measuring an attenuation value for each received attenuation measurement signal and transmit the average attenuation value to the SLAC execution unit 110 of the electric vehicle 100. When the SLAC execution unit 110 of the electric vehicle 100 receives the average attenuation value from the plurality of chargers, the SLAC execution unit 110 may determine a charger to proceed with charging based on the received average attenuation value. In this case, according to one embodiment, the charger may transmit a parameter that may identify itself along with the average attenuation value. The SLAC execution unit 110 may compare parameters acquired at the beginning of the SLAC procedure with parameters received along with the average attenuation value, use only the average attenuation value received along with the parameters that are the same as the parameters acquired at the beginning of the SLAC procedure, and may not use the average attenuation value received along with the parameters not included in the parameters acquired at the beginning of the SLAC procedure.

The PLC controller 140 may transmit a charging request message to proceed with charging to the corresponding charger 200 when the charger 200 to proceed with charging is determined.

The PLC controller 140 may transmit the charging request message to the charger 200 based on a preset power spectral density (PSD). According to one embodiment, the PSD may be set when an electric vehicle is released. Specifically, the PSD may be set by vehicle manufacturers in consideration of vehicle system characteristics. During an electric vehicle development process, the vehicle manufacturers may proceed with charging in charging systems of various manufacturers and set a PSD value as a default value according to the vehicle characteristics.

To ensure smooth charging between electric vehicles and chargers (charging systems), vehicle manufacturers and charging system manufacturers may set a PSD for each frequency band to follow a reference attenuation value of a PLC module that manages PLC as specified in the standard document ISO 15118-3 and then release the electric vehicle. The PLC module for PLC is composed of 9 channels in a frequency band of 2 to 28 MHz.

The charger 200 may receive the charging request message and transmit a response message to the electric vehicle 100. Accordingly, the PLC controller 140 may receive the response message from the charger 200. When the PLC controller 140 does not receive the response message to the charging request message within a predetermined time, the charging request message may be retransmitted to the charger 200.

The PLC controller 140 may determine whether to receive the response message from the charger 200 after transmitting the charging request message to the charger 200. When receiving the response message from the charger 200, the PLC controller 140 may perform charging control based on the PSD currently set as the default value.

When the PLC controller 140 does not receive the response message from the charger 200 after transmitting the charging request message to the charger 200, the PLC controller 140 may transmit the charging request message to the charger 200 a preset number of times until receiving the response message from the charger 200. When the PLC controller 140 does not receive the response message from the charger 200 even after transmitting the charging request message the preset number of times, the PLC controller 140 may determine that communication is impossible and communication is interrupted. That is, when the PLC controller 140 does not receive the response message even after transmitting the charging request message to the charger 200 the preset number of times, the PLC controller 140 may determine that communication is impossible and communication is interrupted.

According to another embodiment, when the PLC controller 140 does not receive the response message from the charger 200 within a preset time from a time point when a first charging request message is sent to the charger 200, the PLC controller 140 may determine that communication is impossible and communication is interrupted. In addition, the PLC controller 140 may determine that communication with the charger 200 is impossible and communication with the charger 200 is interrupted based on various conditions.

When transmitting the charging request message to the charger 200, the PLC controller 140 may change the PSD of the signal transmitted to the charger 200.

As described above, during the development process of an electric vehicle, vehicle manufacturers proceed with charging in charging systems of various manufacturers and set the default value of the PSD according to the vehicle characteristics, but cannot verify whether charging is possible in all charging systems, and in addition, when a new charging system is installed after the vehicle is released, a PSD of a single set communication signal cannot be enough to ensure successful charging in the corresponding charging system. In addition, even when an intermittent communication disconnection phenomenon with a specific charger occurs and the PSD of the communication signal is tuned to successfully charge, when a tuning value is applied to proceed with charging in another charging system, the above problem cannot be solved and the communication disconnection phenomenon may occur.

Accordingly, in general, when charging is performed by setting the strength of the PLC communication signal based on the PSD set as the default and communication matching failure and communication interruption occur at a specific time point or in a specific charging system, the PLC controller 140 of the electric vehicle 100 may recognize the communication matching failure and the communication interruption and attempt charging by applying a PSD with a different profile from the PSD of the default setting.

To this end, the memory 130 may store a plurality of PSD profiles. The plurality of PSD profiles may include a PSD profile set as a default value. In addition, the plurality of PSD profiles may include a PSD profile different from the PSD profile set as the default value.

Another PSD profile may be a profile that may perform charging well in a specific charging system during the vehicle development process by vehicle manufacturers or a profile that may compensate for communication quality in response to noise that occurs as voltage/current changes during the charging process. The type of PSD profile may be diverse.

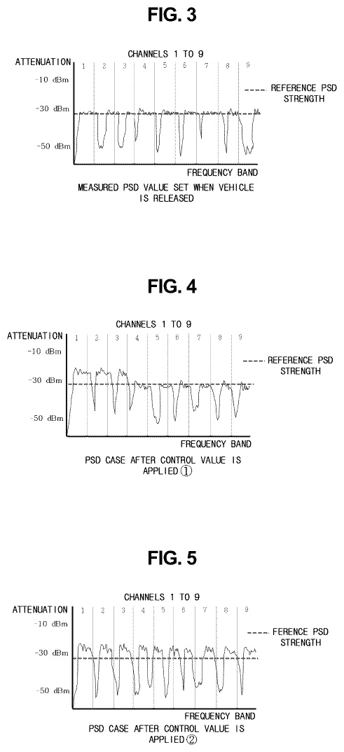

FIGS. 3 to 5 are views showing a plurality of PSD profiles stored in a memory according to one embodiment of the present disclosure.

Referring to FIGS. 3 to 5, the memory 130 may store a plurality of PSD profiles. FIG. 3 shows a reference PSD set as a default value, and FIGS. 4 and 5 show PSD profiles different from a reference PSD.

The PSD profile shown in FIG. 4 has a PSD larger than the reference PSD in channels 1 to 4, and the PSD is the same as the reference PSD in channels 5 to 9. That is, the PSD profile shown in FIG. 4 may be a PSD of a lower frequency band among nine frequency bands of PLC, that is, an increased strength of the communication signal.

The PSD profile shown in FIG. 5 has a PSD larger than the reference PSD in channels 1 to 9. That is, the PSD profile shown in FIG. 5 has a PSD of a total of nine frequency bands (channels), that is, an increased strength of the communication signal.

When transmitting the charging request message to the charger 200, the PLC controller 140 may change the strength of the communication signal transmitted to the charger 200.

To this end, the communication signal strength setting unit 120 may set the strength of the signal transmitted to the charger 200. The communication signal strength setting unit 120 may set the strength of the communication signal transmitted to the charger 200 according to one of the plurality of PSD profiles stored in the memory 130. Specifically, the communication signal strength setting unit 120 may set a communication signal strength value according to the PSD profile in descending order of communication strength learning factor values among the plurality of PSD profiles stored in the memory 130 as the strength of the communication signal.

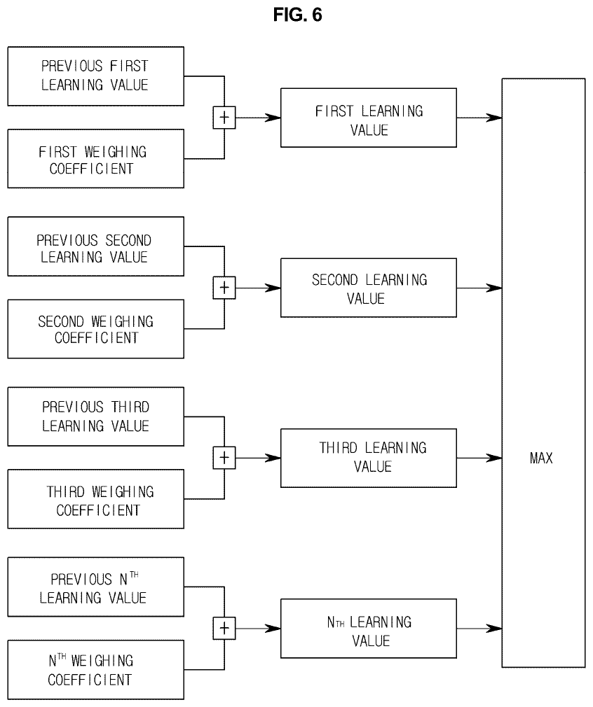

FIG. 6 is a view for describing the operation of a communication signal strength setting unit according to one embodiment of the present disclosure.

Referring to FIG. 6, the communication signal strength setting unit 120 may apply various PSD profiles stored in the memory 130 and learning values for each PSD in order to set the communication signal strength value to be used when the PLC controller 140 transmits the charging request message to the charger 200.

According to one embodiment, when the initial setting or communication matching failure and communication interruption occur and the communication signal strength needs to be re-set, the communication signal strength setting unit 120 may apply a communication signal strength value according to the PSD profile that was first stored in the memory 130. When charging fails even after the set communication signal strength value is applied, the communication signal strength setting unit 120 may apply a communication signal strength value according to the next PSD profile in the order stored in the memory 130.

According to another embodiment, the communication signal strength setting unit 120 may set the communication signal strength value using the learning value for each PSD profile according to the method shown in FIG. 4.

Referring to FIG. 6, when communication matching failure and communication interruption occur, the communication signal strength setting unit 120 may set the communication signal strength value based on the learning value calculated for each PSD profile stored in the memory 130 and attempt communication for charging. For example, the communication signal strength setting unit 120 may set the communication signal strength value according to the PSD profile having the greatest learning value among the learning values calculated for each PSD profile.

When the PLC controller 140 performs communication according to the set communication signal strength value but communication matching failure and communication interruption occur again and charging fails, the communication signal strength setting unit 120 may re-set the communication signal strength value according to a PSD profile with the second greatest learning value. The communication signal strength setting unit 120 may repeatedly perform such a repeated setting until charging is successful. Alternatively, the communication signal strength setting unit 120 may repeat such a repeated setting only a preset number of times, and when charging fails even after the repeated setting is performed the corresponding number of times, it may be determined to be a final charging failure.

When the PLC controller 140 performs communication according to the set communication signal strength value and charging is successful, the communication signal strength setting unit 120 may update the corresponding learning value. For example, since a first learning value for a first PSD profile is the greatest, the communication signal strength value may be set according to the first PSD profile, and when charging is successful, the first learning value may be calculated according to the following Equation 1.

Learning value=previous learning value+(1×weight coefficient) [Equation 1]

Here, a weighting coefficient may have different values for each PSD profile or have the same value. For example, when weighting coefficients for all PSD profiles are 1, the learning value may increase by 1 each time the PLC controller 140 performs communication according to the communication signal strength value according to the corresponding PSD profile and succeeds in charging.

According to another embodiment, a weighting coefficient may have different values according to preference. For example, a weighting coefficient for a PSD profile having a higher PSD than others may have a greater value than weighting coefficients for other PSD profiles. According to another embodiment, the weighting coefficient may be set differently based on the preference of the charger. For example, the weighting coefficient may be set as 0 for a PSD profile that the charger cannot provide. Then, the corresponding PSD profile may not be selected.

The update of the learning value according to Equation 1 may be performed only when charging is successful, and the previous learning value may be maintained when charging is unsuccessful. Accordingly, the learning value may be regarded as a history of previous charging success, and the larger the value, the higher the probability of successful charging. The learning value may be stored in the memory 130 in conjunction with the PSD profile.

The PLC controller 140 may transmit the charging request message to the charger 200 according to the communication signal strength value determined by the communication signal strength setting unit 120. The PLC controller 140 may transmit the charging request message to the charger 200 until the number of transmissions of the charging request message becomes a reference value for determining communication interruption.

The PLC controller 140 may stop transmitting the corresponding charging request message to the charger 200 when the number of transmissions of the charging request message becomes the reference value for determining communication interruption. At this time, the communication signal strength setting unit 120 may newly determine the communication signal strength value and notify the PLC controller 140. The communication signal strength setting unit 120 may newly determine the communication signal strength value based on the above method.

The PLC controller 140 may transmit the charging request message to the charger 200 through the transmitter 150 according to the communication signal strength value newly determined by the communication signal strength setting unit 120.

When receiving the response signal from the charger 200 through the receiver 160, the PLC controller 140 may transmit a message indicating that the response has been received to the communication signal strength setting unit 120, and the communication signal strength setting unit 120 may update the learning value for the corresponding PSD profile according to Equation 1 and store the updated PSD profile in the memory 130.

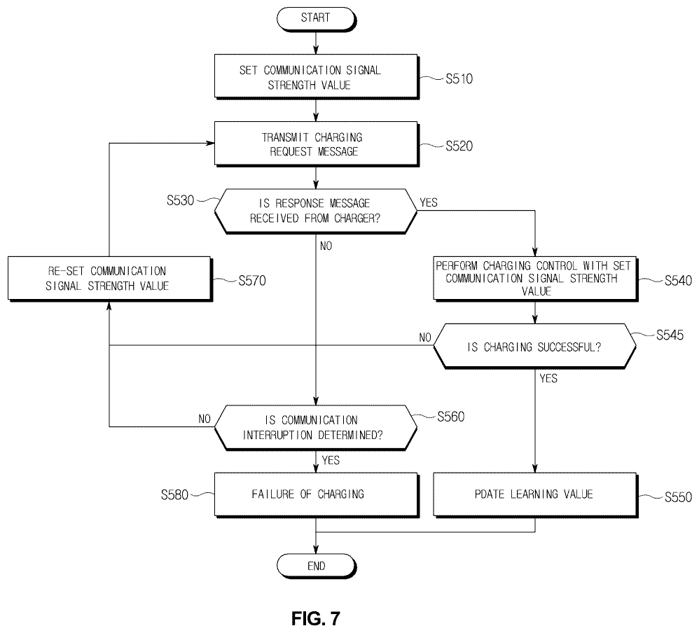

FIG. 7 is a flowchart showing a method of charging an electric vehicle according to one embodiment of the present disclosure.

Referring to FIG. 7, when the charger 200 to proceed with charging is determined, the electric vehicle 100 may proceed with charging with the corresponding charger 200.

In operation S510, the electric vehicle 100 may set a communication signal strength value to be used when the PLC controller 140 transmits the charging request message. According to one embodiment, the electric vehicle 100 may select one of the PSD profiles stored in the memory 130 and set the communication signal strength value according to the corresponding PSD profile.

The electric vehicle 100 may select a PSD profile in various ways. According to one embodiment, the electric vehicle 100 may select the PSD profile used in the previous charging, select the PSD profile set as the default when the electric vehicle is released, select the PSD profile having the greatest learning value, select the PSD profile first stored in the memory 130, or randomly select one of the PSD profiles stored in the memory 130.

In operation S520, the electric vehicle 100 may transmit the charging request message to the charger 200, and in operation S530, the electric vehicle 100 may determine whether the charger response message has been received from the charger 200.

According to one embodiment, the electric vehicle 100 may transmit the charging request message multiple times. For example, the electric vehicle 100 may transmit the charging request message multiple times at preset time intervals until receiving the charger response message. Alternatively, when the charger response message is not received within the preset time after the charging request message is transmitted, the charging request message may be retransmitted.

In operation S530, when the charger response message is received from the charger 200, the electric vehicle 100 may perform charging control with the set communication signal strength value in operation S540.

Even while the electric vehicle 100 proceeds with charging, there is a possibility that the PLC communication is interrupted and the charging fails. In operation S545, the electric vehicle 100 may determine whether the charging is successful, and when the charging is not successful, the electric vehicle 100 may proceed to operation S570 to re-set the communication signal strength value. This will be described in detail below.

When determining that the charging is successful in operation S545, the electric vehicle 100 proceeds to operation S550 to update the learning value for the set PSD profile according to Equation 1. The updated learning value may be stored in the memory 130.

In operation S530, when not receiving the charger response message from the charger 200, the electric vehicle 100 may determine whether to stop communication with the charger 200. According to one embodiment, when transmitting the charging request message to the charger 200 using a preset number of PSD profiles but not receiving the charger response message, the electric vehicle 100 may determine communication interruption.

When it is determined not to stop communication in operation S560, the electric vehicle 100 may re-set the communication signal strength value in operation S570. That is, the electric vehicle 100 may select a PSD profile different from the PSD profile used to establish communication with the charger and re-set the communication signal strength value based on the selected PSD profile.

According to one embodiment, the electric vehicle 100 may select one of the remaining PSD profiles excluding the previously selected PSD profile for this charging.

For example, the electric vehicle 100 may select a PSD profile with the greatest learning value among the remaining PSD profiles. In addition, the electric vehicle 100 may select a PSD profile with the highest preference among the remaining PSD profiles. Here, the preference may be preset by a driver.

When the electric vehicle 100 determines to stop communication with the charger 200 in operation S560, the electric vehicle 100 may display an alarm indicating that charging has failed and search for another charger that may proceed with charging in operation S580. When another charger is found, the electric vehicle 100 may re-perform the operations shown in FIG. 5 for charging.

Various embodiments of the present disclosure as described above are intended to solve the problem of charging being interrupted due to communication interruption due to noise in PLC and other reasons during the charging process of the electric vehicle, and the problem of charging interruption can be solved by storing communication strength values having various profiles in the memory and applying them if necessary with respect to parts that may occur by using only the communication strength values stored in the conventional electric vehicle charging controller to perform stable charging in an electric vehicle operating environment and charging system.

According to various embodiments of the present disclosure, the charging interruption problem that can be caused by using only the signal strength value stored in the charging controller of the conventional electric vehicle can be solved by storing the signal strength values of various profiles in the memory and applying one of the signal strength values of various profiles if necessary. Accordingly, it is possible to solve the problem of charging being interrupted due to communication interruption, for example, due to noise in power line communication and other reasons during the charging process of the electric vehicle and perform stable charging in the electric vehicle operating environment and the charging system.

What is claimed is:

1. A charging device for a vehicle, the charging device comprising:
a memory configured to store a plurality of power spectra density profiles;
a communication signal strength setting module configured to set a communication signal strength based on one of the plurality of power spectra density profiles stored in the memory; and
a power line communication (PLC) controller configured to transmit a signal having the set communication signal strength to a charger.

2. The charging device of claim 1, wherein the vehicle is an electric vehicle.

3. The charging device of claim 2, wherein the charger is an electric vehicle supply equipment (EVSE).

4. The charging device of claim 1, wherein the charger is external to the vehicle.

5. The charging device of claim 1, wherein the communication signal strength setting module calculates a learning value for each of the plurality of power spectra density profiles.

6. The charging device of claim 5, wherein the learning value for a power spectra density profile of the plurality of power spectra density profiles used when charging is successful is calculated by adding a weighting coefficient to a previous learning value.

7. The charging device of claim 5, wherein the communication signal strength setting module selects a power spectra density profile with a greatest learning value among the plurality of power spectra density profiles, and
sets a communication signal strength based on the selected power spectra density profile.

8. The charging device of claim 1, wherein the communication signal strength setting module randomly selects one of the plurality of power spectra density profiles or selects a power spectra density profile with a highest preference based on a preference set by a driver, and
sets a communication signal strength based on the selected power spectra density profile.

9. The charging device of claim 1, wherein the PLC controller is configured to determine whether the number of times the signal has been transmitted to the charger exceeds a communication interruption determination reference value when not receiving a response signal from the charger after transmitting a signal having the set communication signal strength to the charger.

10. The charging device of claim 9, wherein the PLC controller determines that communication is impossible and communication is interrupted when the number of times the signal has been transmitted to the charger exceeds the communication interruption determination reference value.

11. The charging device of claim 9, wherein the PLC controller is configured to:
perform charging control with a signal having the set communication signal strength when receiving the response signal from the charger; and
request the communication signal strength setting module to re-set the communication signal strength when charging fails while performing the charging control.

12. A vehicle comprising the charging device of claim 1.

13. An electric vehicle comprising the charging device of claim 1.

14. A method of charging a charging device for a vehicle, the method comprising:
storing, by a memory, a plurality of power spectra density profiles;
setting, by communication signal strength setting module, a communication signal strength based on the plurality of power spectra density profiles stored in the memory; and
transmitting, by a power line communication (PLC) controller, a message to a charger with a signal having the set communication signal strength.

15. The method of claim 14, further comprising:
calculating a learn value for each of the plurality of power spectra density profiles and storing the learn values in the memory.

16. The method of claim 15, further comprising:
calculating a learning value for a power spectra density profile of the plurality of power spectra density profiles used when charging is successful by adding a weighting coefficient to a previous learning value.

17. The method of claim 15, wherein the setting of the communication signal strength comprises:
selecting a power spectra density profile with a greatest learning value among the plurality of power spectra density profiles; and
setting a communication signal strength based on the selected power spectra density profile.

18. The method of claim 14, wherein the setting of the communication signal strength comprises:
randomly selecting one of the plurality of power spectra density profiles or selecting a power spectra density profile with a highest preference based on a preference set by a driver; and
setting a communication signal strength based on the selected power spectra density profile.

19. The method of claim 14, further comprising:
determining whether the number of times the signal has been transmitted to the charger exceeds a communication interruption determination reference value when not receiving a response signal from the charger after transmitting a signal having the set communication signal strength to the charger; and
determining that communication is impossible and communication is interrupted when the number of times the signal has been transmitted to the charger exceeds the communication interruption determination reference value.

20. The method of claim 14, further comprising:
performing charging control with a signal having the set communication signal strength when receiving a response signal from the charger after transmitting a signal having the set communication signal strength to the charger; and
re-setting the communication signal strength when charging fails during the performing of the charging control.
